(19) United States
(12) Patent Application Publication
(10) Pub. No.: US 2020/0108782 A1
(43) Pub. Date: Apr. 9, 2020

(54) VEHICLE MOBILE DEVICE HOLDER

(71) Applicant: Ford Global Technologies, LLC, Dearborn, MI (US)

(72) Inventors: Perry Robinson MACNEILLE, Lathrup Village, MI (US); Bo WU, Northville, MI (US)

(21) Appl. No.: 16/499,245

(22) PCT Filed: Mar. 31, 2017
(86) PCT No.: PCT/US2017/025423

§ 371 Date: Sep. 28, 2019

(51) Int. Cl. B60R 11/02; H04M 1/04; H04N 5/232; H04N 5/225; G07C 5/00; F16M 11/20; F16M 11/10; F16M 11/28; F16M 11/04; F16M 11/18; F16M 13/02

(52) U.S. Cl. CPC B60R 11/0241; H04M 1/04; H04N 5/23299; H04N 5/2253; G07C 5/008; B60R 2011/0005; F16M 11/10; F16M 11/28; F16M 11/041; F16M 11/18; F16M 13/02; F16M 11/2014

(57) ABSTRACT

A mobile device holder includes a base configured to rotate. A mechanical linkage is attached to the base and configured to receive a mobile device. A servomechanism is operably connected to the base and configured to rotate the base in accordance with vehicle dynamics data and an image captured by the mobile device.

### BACKGROUND

Mobile phones have replaced several devices carried by consumers. Many consumers use their mobile phone as their primary camera, music player, electronic reader, and of course, telephone. Some people use their mobile phone as their primary navigation tool. As a result, vehicle mobile phone holders, which allow a user to mount his or her mobile phone to the vehicle dashboard, have increased in popularity.

### BRIEF DESCRIPTION OF THE FIGURES

FIG. 1 illustrates an example vehicle with a rotating mobile device holder for tracking an object external to the vehicle.

FIGS. 2A and 2B illustrate front and side views, respectively, of an example mobile device holder.

FIG. 2C is a block diagram showing example components of the vehicle, the mobile device holder, and a mobile device.

FIGS. 3A-3C illustrate views from the vehicle where the mobile device is tracking an object.

FIG. 4 illustrates the mobile device holder rotating in the direction of the vehicle headlights.

FIGS. 5A and 5B illustrate the mobile device holder adjusting its position relative to the pitch of the vehicle.

FIG. 6 is a flowchart of an example process that may be executed by a vehicle processor.

FIG. 7 is a flowchart of another example process that may be executed by the vehicle processor.

FIG. 8 is a flowchart of an example process that may be executed by a mobile processor.

### DETAILED DESCRIPTION

A typical mobile phone holder can be adjusted so the driver can see the mobile phone screen while operating a vehicle. The adjustments are limited to moving the mobile phone up, down, left, or right. The adjustments are performed manually. If the driver wishes to use his or her mobile phone as a dashboard mounted camera, the driver can manually turn the mobile phone holder so the camera of the mobile phone is pointed out the windshield. The only way to adjust the direction of the camera is for the driver to manually adjust the mobile phone holder. Therefore, the camera in a typical mobile phone holder cannot be used to track an object external to the vehicle. Also, in instances where the vehicle is equipped with adaptive headlights, the camera cannot point in the direction of the headlights while the vehicle is turning even though the target for the headlights moves with the vehicle, and the driver may wish for the camera to track the target.

One way to address these issues is by providing vehicle dynamics data to the mobile device and allowing the mobile device to control the direction of the mobile device holder. In such instances, the mobile device holder has a base that is configured to rotate, a mechanical linkage attached to the base and configured to receive a mobile device, and a servomechanism operably connected to the base and configured to rotate the base. The servomechanism rotates the base in accordance with vehicle dynamics data and an image captured by the mobile device. That is, the mobile device may receive the vehicle dynamics data and images captured by a camera incorporated into the mobile device. The mobile device may process the vehicle dynamics data and the images, and output signals to control the servomechanism so that the base will rotate in a way that allows the mobile device to track an object external to the vehicle.

In one possible implementation, a mobile device holder includes a base configured to rotate, a mechanical linkage attached to the base and configured to receive a mobile device, and a servomechanism operably connected to the base and configured to rotate the base in accordance with vehicle dynamics data and an image captured by the mobile device.

The vehicle dynamics data may include at least one of a change in propulsion, brake pressure, a steering angle, a suspension height, a velocity of a host vehicle, an output of a gyroscope or accelerometer, and a headlight direction. When the vehicle dynamics data includes the output of the gyroscope or accelerator, the output of the gyroscope or accelerator indicates whether the host vehicle is at least one of pitching, rolling, and heaving.

In some possible approaches, the servomechanism may be configured to receive a control signal output by the mobile device, the control signal representing an angular or linear position, and rotate to the angular or linear position represented by the control signal. The servomechanism may be configured to receive a control signal output by a vehicle processor, the control signal representing an angular or linear position, and rotate to the angular or linear position represented by the control signal.

In some possible implementations, the mobile device holder includes an actuator operatively connected to the mechanical linkage. The actuator may be configured to receive a control signal from one of the mobile device and a vehicle processor and tilt the mobile device up based at least in part on vehicle dynamics data indicating that a host vehicle is pitching forward. The actuator may be configured to receive a control signal from one of the mobile device and a vehicle processor and tilt the mobile device down based at least in part on vehicle dynamics data indicating that a host vehicle is pitching backward. Movement of the actuator may cause the mechanical linkage to telescope.

The mobile device holder may further include an accessory interface configured to communicatively connect the mobile device to a vehicle communication interface.

An example vehicle system includes a mobile device holder having a base configured to rotate, a mechanical linkage attached to the base and configured to receive a mobile device, and a servomechanism operably connected to the base and configured to rotate the base in accordance with vehicle dynamics data and an image captured by the mobile device. The vehicle system further includes a vehicle processor, in a host vehicle, programmed to output the vehicle dynamics data to the mobile device.

The vehicle dynamics data includes at least one of a change in brake pressure, a steering angle, a suspension height, a velocity of the host vehicle, an output of a gyroscope or accelerometer, and a headlight direction. In instances where the vehicle dynamics data includes the output of the gyroscope, the output of the gyroscope or accelerometer indicates whether the host vehicle is at least one of pitching, rolling, and heaving.

The servomechanism may be configured to receive a control signal output by the mobile device, the control signal representing an angular or linear position, and rotate to the angular or linear position represented by the control signal. The servomechanism may be configured to receive a control signal output by the vehicle processor, the control signal representing an angular or linear position, and rotate to the angular or linear position represented by the control signal.

The vehicle system may further include a vehicle communication interface. In this instance, the device holder may include an accessory interface configured to communicatively connect the mobile device to the vehicle communication interface. The vehicle processor may be programmed to command the communication interface to transmit the vehicle dynamics data to the mobile device via the accessory interface.

In instances where the device holder includes an actuator operatively connected to the mechanical linkage, the actuator may be configured to receive a control signal from one of the mobile device and the vehicle processor and tilt the mobile device up based at least in part on vehicle dynamics data indicating that a host vehicle is pitching forward. In other instances where the device holder includes an actuator operatively connected to the mechanical linkage, the actuator may be configured to receive a control signal from one of the mobile device and the vehicle processor and tilt the mobile device down based at least in part on vehicle dynamics data indicating that a host vehicle is pitching backward.

Another vehicle system includes a mobile device holder having a base configured to rotate, a mechanical linkage attached to the base and configured to receive a mobile device, and a servomechanism operably connected to the base and configured to rotate the base in accordance with vehicle dynamics data and an image captured by the mobile device. A vehicle processor, in a host vehicle, is programmed to receive the image captured by the mobile device, generate a control signal based on the image and the vehicle dynamics data, and output the control signal to the servomechanism. The servomechanism rotates the base to point a camera of the mobile device toward an object external to the host vehicle that appears in the image to track the image while the host vehicle is moving.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

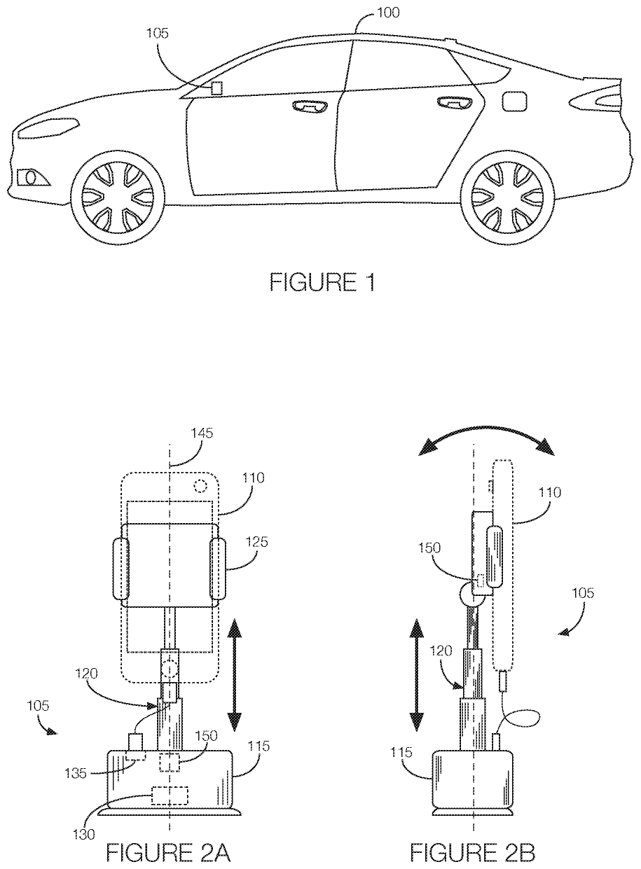

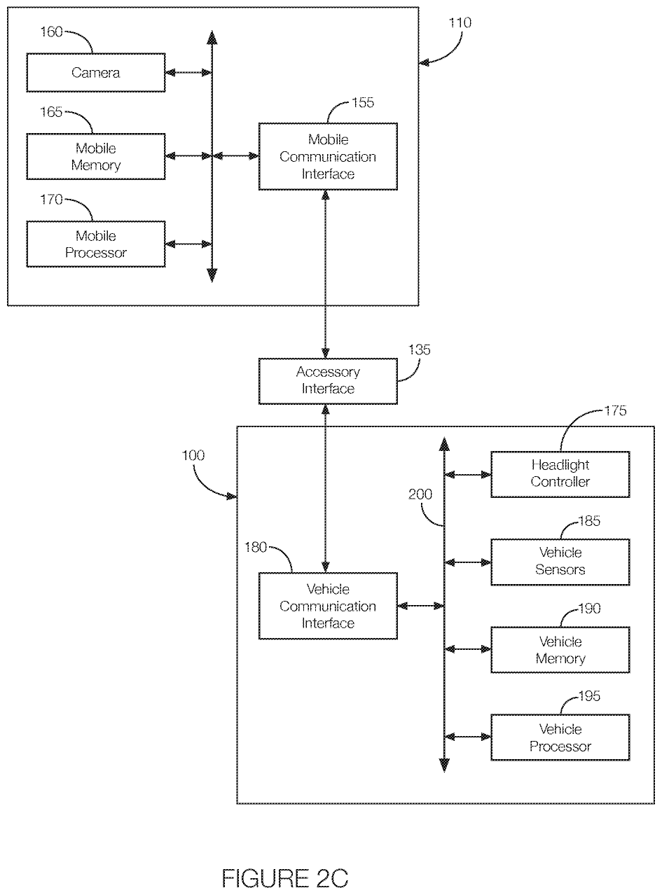

As illustrated in FIGS. 1-2B, a host vehicle 100 has a device holder 105 for tracking an object external to the host vehicle 100. Although illustrated as a sedan, the host vehicle 100 may be any passenger or commercial automobile such as a car, a truck, a sport utility vehicle, a crossover vehicle, a van, a minivan, a taxi, a bus, etc. As discussed in greater detail below, movement of the device holder 105 is controlled by signals output by a mobile device 110 placed in the device holder 105. The mobile device 110 or the host vehicle 100 can control the device holder 105 according to images captured by the mobile device 110, vehicle dynamics data, or both. Vehicle dynamics data may refer to a characteristic of the host vehicle 100 such as a change in propulsion, brake pressure, a steering angle, a suspension height, a velocity, the output of a gyroscope, such as a MEMS gyroscope, or an accelerometer, headlight direction, etc.

FIGS. 2A-2B illustrate front and side views of an example device holder 105. FIG. 2C is a block diagram illustrating example components of the host vehicle 100, the device holder 105, and the mobile device 110. The components of the device holder 105 include a base 115, a mechanical linkage 120, a grip 125, a servomechanism 130, and an accessory interface 135.

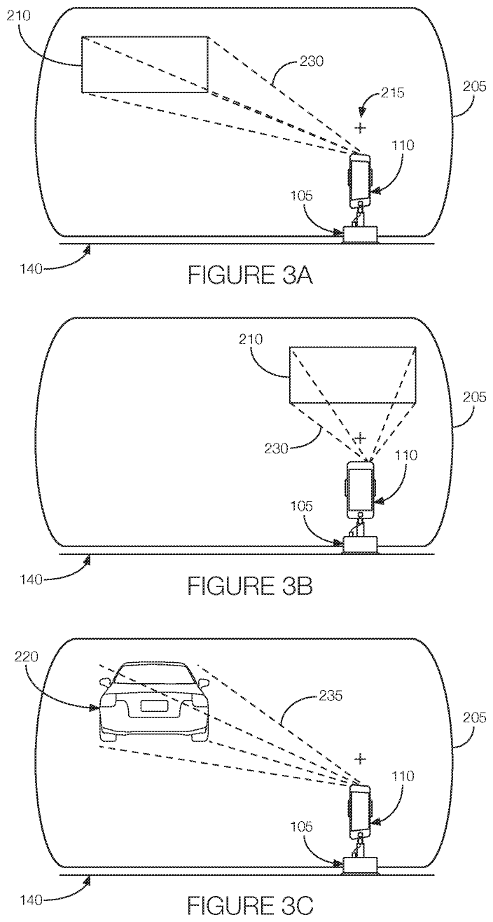

The base 115 is formed from a rigid material, such as plastic, at least a portion of which can rotate relative to a vehicle dashboard 140 (see FIGS. 3A and 3B). When the base 115 is mounted to the vehicle dashboard 140, at least part of the base 115 can rotate about an axis 145 extending perpendicular to a surface of the vehicle dashboard 140 on which the base 115 is mounted. The mechanical linkage 120 extends from the base 115.

The mechanical linkage 120 is formed from a rigid material, such as plastic, and can support the weight of the mobile device 110. The mechanical linkage 120 may have various joints and links located throughout and which provide various degrees of freedom. Examples of joints may include hinged (revolute) joints, sliding (prismatic) joints, cylindrical joints, and ball joints. Examples of links may be rigid links or telescoping links. Thus, the mechanical linkage 120 may telescope or tilt relative to the base 115, as shown by the arrows in FIGS. 2A and 2B. That way, the mechanical linkage 120 may move allow the mobile device 110 to move relative to the base 115. Also, in this way, the mechanical linkage 120 is a mechanical linkage 120 with, e.g., three translational degrees of freedom and, e.g., three rotational degrees of freedom.

The grip 125 may be formed from, e.g., plastic and may include fingers for holding the mobile device 110 in place. The grip 125 may receive the mobile device 110 and hold the mobile device 110 using a clip, bracket, etc. In some instances, the grip 125 uses friction to hold the mobile device 110 in place.

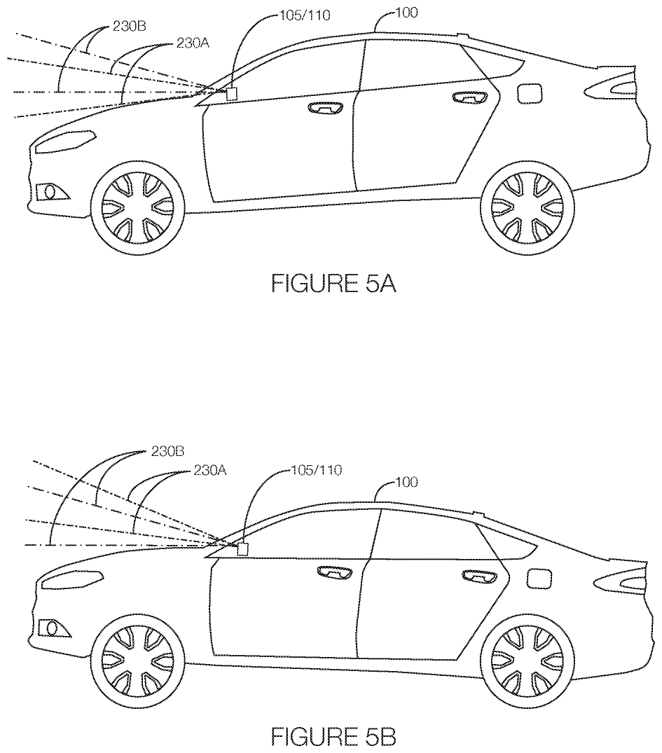

The servomechanism 130, sometimes referred to as a servo, is an electric motor or another type of actuator that converts electrical energy into motion. The servomechanism 130 may have a shaft that rotates in accordance with electrical energy provided to the servomechanism 130. The servomechanism 130 may be programmed or configured to rotate to particular angular or linear positions in accordance with a control signal provided to the servomechanism 130. The shaft of the servomechanism 130 may be operatively connected to the rotating portion of the base 115. The rotation of the shaft of the servomechanism 130 causes at least a portion of the base 115 to rotate. Other actuators 150, acting on the various joints and links of the mechanical linkage 120, may be incorporated into the device holder 105 that, e.g., cause the device holder 105 to rotate or move in other directions in accordance with a control signal received from the mobile device 110. For instance, an actuator 150 may cause the mechanical linkage 120 to tilt up or down depending on whether the host vehicle 100 is pitching forward or backward, respectively, as discussed in greater detail with respect to FIGS. 5A and 5B, below. Another actuator 150 may cause the mechanical linkage 120 to telescope (i.e., extend away from or toward the base 115). The actuator 150 may be operatively attached to the base 115, the mechanical linkage 120, or both. Thus, the servomechanism 130 may facilitate various degrees of freedom, such as three translational degrees of freedom and three rotational degrees of freedom, for the device holder 105.

The accessory interface 135 is implemented via circuits, chips, or other electronic components that allow components of the mobile device 110 to communicate with components of the host vehicle 100, and vice versa. The accessory interface 135 may also facilitate communication between components of the mobile device 110 and other components of the device holder 105, such as the servomechanism 130. The accessory interface 135 may facilitate wired or wireless communication between and among the components of the host vehicle 100, the mobile device 110, and the device holder 105. The accessory interface 135 may be implemented via any number of hardware or wireless communication protocols. Examples of such protocols could include the Universal Serial Bus (USB) hardware protocol and the Bluetooth® wireless communication protocol.

The components of the mobile device 110 include a mobile communication interface 155, a camera 160, a mobile memory 165, and a mobile processor 170.

The mobile communication interface 155 is implemented via an antenna, circuits, chips, or other electronic components that facilitate wireless communication between the components of the mobile device 110, the host vehicle 100, and the device holder 105. For instance, the mobile communication interface 155 may be in wired or wireless communication with the accessory interface 135. The mobile communication interface 155 may be programmed to communicate in accordance with any number of wired or wireless communication protocols. For instance, the mobile communication interface 155 may be programmed to communicate in accordance with a satellite-communication protocol, a cellular-based communication protocol (LTE, 3G, etc.), Bluetooth®, Bluetooth® Low Energy, Ethernet, the Controller Area Network (CAN) protocol, WiFi, the Local Interconnect Network (LIN) protocol, the Universal Serial Bus (USB) protocol, etc. As discussed in greater detail below, the mobile communication interface 155 receives vehicle dynamics data from the host vehicle 100 and passes that data to the mobile processor 170, stores that data in the mobile memory 165, or both.

The camera 160 is a vision sensor incorporated into the mobile device 110. The camera 160 may capture images of objects external to the host vehicle 100 when, e.g., the mobile device 110 is mounted in the device holder 105. To capture such images, the camera 160 may include a lens that projects light toward, e.g., a CCD image sensor, a CMOS image sensor, etc. The camera 160 processes the light and generates the image. The image may be output to the mobile processor 170 and, as discussed in greater detail below, can be used to track images external to the host vehicle 100. The camera 160 may be incorporated into the mobile device 110, and when the mobile device 110 is placed in the device holder 105, the camera 160 may point toward a window, such as the windshield 205, of the host vehicle 100.

The mobile memory 165 is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store instructions executable by the mobile processor 170 and data such as images captured by the camera 160, vehicle dynamics data received from the host vehicle 100, or both. The instructions and data stored in the memory may be accessible to the mobile processor 170 and possibly other components of the mobile device 110.

The mobile processor 170 is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The mobile processor 170 is programmed to receive the data from the camera 160, the mobile memory 165, or both, and control the servomechanism 130 of the device holder 105 to rotate the base 115. For instance, the mobile processor 170 may be programmed to retrieve images captured by the camera 160 from the mobile memory 165. In some implementations, the mobile processor 170 is programmed to receive the images captured by the camera 160 in real-time. The mobile processor 170 is programmed to process the images to detect an object. The mobile processor 170 may be further programmed to receive vehicle dynamics data. As discussed above, vehicle dynamics data may refer to a characteristic of the host vehicle 100 such as a change in propulsion brake pressure, a steering angle, a suspension height, a velocity, the output of a gyroscope, such as a MEMS gyroscope, or an accelerometer, etc. The mobile processor 170 may be programmed to process the vehicle dynamics data and the image to predict where the object will be relative to the host vehicle 100. The mobile processor 170 may be further programmed to confirm its prediction by continually monitoring the location of the object via the images. Further, the mobile processor 170 may be programmed to command the servomechanism 130 of the device holder 105 to rotate to particular angular or linear positions based on the predicted or detected location of the object. The mobile processor 170 may be programmed to output control signals commanding the servomechanism 130 to particular angular or linear positions so the object will remain in the field of view of the camera 160.

The components of the host vehicle 100 include a headlight controller 175, a vehicle communication interface 180, vehicle sensors 185, a vehicle memory 190, and a vehicle processor 195. These components may be in communication with one another via a vehicle communication link 200. The vehicle communication link 200 may be implemented via any number of communication protocols such as Ethernet, the Controller Area Network (CAN) protocol, WiFi, the Local Interconnect Network (LIN) protocol, Bluetooth®, Bluetooth® Low Energy, etc.

The headlight controller 175 is implemented via circuits, chips, or other electronic components that control the direction of the vehicle headlights. This is sometimes referred to as adaptive headlight positioning. During a cornering maneuver (e.g., when the host vehicle 100 is turning), the headlight controller 175 outputs control signals to actuators operatively connected to the vehicle headlights. The control signals cause the actuators to point the vehicle headlights in the direction of the turn, and the headlight controller 175 may be programmed to output the control signal in accordance with the angle of the steering wheel. Thus, while the host vehicle 100 is steered toward the right during a cornering maneuver, the headlight controller 175 may be programmed to output a control signal that causes the actuators to point the vehicle headlights toward the right. While the host vehicle 100 is steered toward the left during a cornering maneuver, the headlight controller 175 may be programmed to output a control signal that causes the actuators to point the vehicle headlights toward the left. The headlight controller 175 may be programmed to output a control signal to center the vehicle headlights when no cornering maneuver is being performed.

The vehicle communication interface 180 is implemented via an antenna, circuits, chips, or other electronic components that facilitate wireless communication between the components of the mobile device 110, the host vehicle 100, and the device holder 105. For instance, the vehicle communication interface 180 may be in wired or wireless communication with the accessory interface 135. The vehicle communication interface 180 may be programmed to communicate in accordance with any number of wired or wireless communication protocols. For instance, the vehicle communication interface 180 may be programmed to communicate in accordance with a satellite-communication protocol, a cellular-based communication protocol (LTE, 3G, etc.), Bluetooth®, Bluetooth® Low Energy, Ethernet, the Controller Area Network (CAN) protocol, WiFi, the Local Interconnect Network (LIN) protocol, the Universal Serial Bus (USB) protocol, etc. As discussed in greater detail below, the vehicle communication interface 180 transmits vehicle dynamics data from the host vehicle 100 and to the mobile processor 170, stores that data in the vehicle memory 190, or both. In some instances, the vehicle communication interface 180 is a standalone device located in the host vehicle 100. Alternatively, the vehicle communication interface 180 may be incorporated into another component of the host vehicle 100, such as a telematics unit.

The vehicle sensors 185 are implemented via circuits, chips, or other electronic components that are programmed to collect data concerning characteristics of the host vehicle 100. Examples of characteristics measured by the vehicle sensors 185 include changes in propulsion, brake pressure, a steering angle, a suspension height, a velocity, the output of a gyroscope, such as a MEMS gyroscope, or an accelerometer, headlight direction, etc. The vehicle sensors 185 are further programmed to output the collected data. The aggregate of the data collected by the vehicle sensors 185 may be referred to as the vehicle dynamics data. The vehicle dynamics data may be output by the vehicle sensors 185 directly to the vehicle processor 195, to the vehicle memory 190, or both.

The vehicle memory 190 is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The vehicle memory 190 may store instructions executable by the vehicle processor 195 and data such as vehicle dynamics data, images captured by the camera 160 of the mobile device 110, or both. The instructions and data stored in the memory may be accessible to the vehicle processor 195 and possibly other components of the host vehicle 100.

The vehicle processor 195 is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The vehicle processor 195 is programmed to receive the vehicle dynamics data from the vehicle sensors 185, process the vehicle dynamics data, and output the vehicle dynamics data to the communication interface. As discussed above, the vehicle dynamics data may refer to a characteristic of the host vehicle 100 such as a change in propulsion, brake pressure, a steering angle, a suspension height, a velocity, the output of a gyroscope, such as a MEMS gyroscope, or an accelerometer, headlight direction, etc. The processor may be programmed to command the communication interface to transmit the vehicle dynamics data to the mobile processor 170 via, e.g., the accessory interface 135.

The vehicle processor 195 may be a standalone device or it may be incorporated into another vehicle component. For instance, the vehicle processor 195 may be incorporated into a vehicle controller such as a body control module, which is a vehicle computer implemented via circuits, chips, or other electronic components.

The vehicle processor 195 may be programmed to receive data about the mobile device 110, the device holder 105, or both. For instance, the vehicle processor 195 may be programmed to determine the angular or linear position of the device holder 105. The angular or linear position of the device holder 105 can be used to determine the angle of the mobile device 110 relative to the object being tracked. That information can be used by the vehicle processor 195 to improve the accuracy of the positioning of the host vehicle 100. For instance, if the object being tracked is another vehicle directly ahead of and in the same lane as the host vehicle 100, the vehicle processor 195 can determine whether the host vehicle 100 is properly within the lane based on the angular or linear position of the device holder 105, the mobile device 110, or both. Further, the vehicle processor 195 may receive and process the image captured by the camera 160 to determine, e.g., visibility. That is, if the image fails to show objects, even objects far away, the vehicle processor 195 may determine that the host vehicle 100 is traveling in low visibility conditions. This conclusion may be confirmed with weather data received via, e.g., a vehicle telematics unit, the vehicle communication interface 180, etc.

In some instances, the vehicle processor 195 is programmed to perform some of the actions of the mobile processor 170, discussed above. That is, the vehicle processor 195 may be programmed to receive and process the images captured by the camera 160 of the mobile device 110 and command the servomechanism 130 to rotate the base 115 to particular angular or linear position to track an object identified in the image.

FIGS. 3A and 3B illustrate views from the host vehicle 100 where the mobile device 110 is tracking an object. Specifically, FIGS. 3A and 3B illustrate the device holder 105 mounted to the vehicle dashboard 140 and tracking an object through the vehicle windshield 205. The mobile device 110 captures images of the object and receives vehicle dynamics data via the accessory interface 135 of the device holder 105. Based on the location of the object in subsequent images and based on the vehicle dynamics data, the mobile processor 170 tracks the object and commands the servomechanism 130 to turn the base 115 of the device holder 105 to continue to track the object. FIGS. 3A and 3B show the mobile phone detecting a billboard 210 (e.g., the object) and tracking the billboard 210 as the host vehicle 100 moves relative to the billboard 210. FIG. 3A illustrates the orientation of the billboard 210 to the host vehicle 100 when the billboard 210 is first detected and FIG. 3B illustrates the orientation of the billboard 210 to the host vehicle 100 at a later time. The mobile device 110 outputs the control signal to the servomechanism 130 of the device holder 105 causing the base 115 of the device holder 105 to rotate toward the billboard 210 despite the movement of the host vehicle 100. By considering the vehicle dynamics data, the mobile device 110 can more accurately track the location of the billboard 210 while the host vehicle 100 is moving.

Further, the windshield 205 may include one or more reference marks 215. The mobile device 110 may detect the reference marks 215 in the images captured by the camera 160 to help orient the mobile device 110 relative to the host vehicle 100. In other words, the mobile processor 170 may be programmed to recognize that the reference marks 215 never move relative to the host vehicle 100. Also, the reference marks 215 may have a constant shape and orientation (shown as crosshairs in FIGS. 3A and 3B). As such, the reference marks 215 can be used by the mobile processor 170 to determine a distance of the host vehicle 100 to objects being tracked, determine a size of the objects being tracked, etc.

In some possible approaches, as shown in FIG. 3C, the mobile device 110 may track another vehicle 220. The vehicle communication interface 180 may wirelessly communicate with the other vehicle 220 via, e.g., a vehicle-to-vehicle communication protocol such as the Dedicated Short Range Communication (DSRC) communication protocol. The messages exchanged may help the vehicle processor 195 confirm the location of the host vehicle 100, improve the accuracy of the positioning of the host vehicle 100, determine visibility (i.e., if the vehicle processor 195 knows the other vehicle 200 is nearby based on the vehicle-to-vehicle communications but the mobile device 110 does not see the other vehicle 220, the vehicle processor 195 may determine that visibility is limited due to, e.g., weather such as fog, a blizzard, or the like).

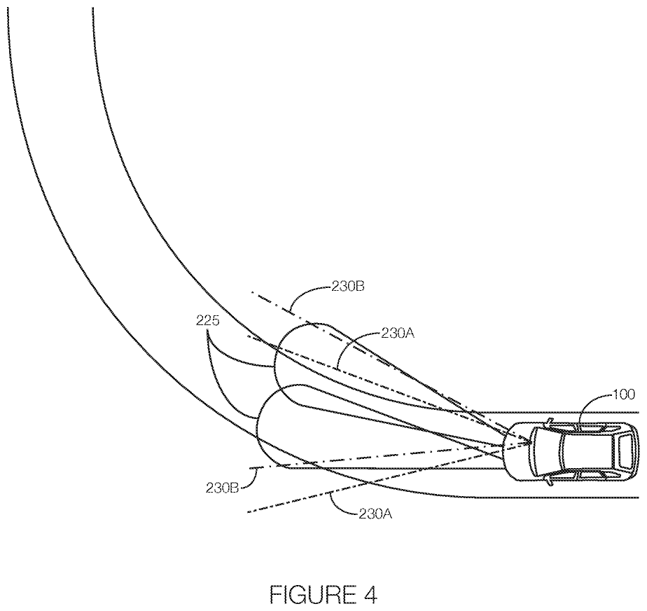

FIG. 4 illustrates how the device holder 105 may be used with an adaptive headlight system. As the direction 225 of the headlights changes, the mobile device 110 may command the servomechanism 130 of the device holder 105 to rotate the base 115 in the direction of the headlights via control signals. The mobile processor 170 may output such control signals in accordance with the vehicle dynamics data, which as discussed above may include steering angle, headlight direction, etc. The field of view 230 of the camera 160 may point in the same direction of the headlights. In FIG. 4, the original field of view of the camera 160 (e.g., the field of view with the headlights pointed straight forward) is shown as 230A and the adjusted field of view is shown as 230B.

FIGS. 5A and 5B illustrate how the mobile device 110 can adjust the device holder 105 to account for the pitch of the host vehicle 100. The vehicle dynamics data may indicate that the vehicle is pitched forward (FIG. 5A) or backward (FIG. 5B). Either pitch will change the field of view of the camera 160, which may interfere with how well the mobile device 110 can track objects outside the host vehicle 100. The mobile processor 170 may correct such issues by commanding the device holder 105 to tilt up in instances of a forward pitch as shown in FIG. 5A or by commanding the device holder 105 to tilt down in instances of a backward pitch as shown in FIG. 5B. The mobile processor 170 may command the device holder 105 to tilt up or down in accordance with vehicle dynamics data representing that the host vehicle 100 is pitched either forward or backward, respectively. In response, the mobile processor 170 may output control signals to an actuator 150 operatively connected to the mechanical linkage 120 for tilting the mechanical linkage 120 up or down. In both FIGS. 5A and 5B, the original field of view of the camera 160 (e.g., the field of view caused by the pitching) is shown as 230A and the adjusted field of view is shown as 230B. Similar concepts may apply while the host vehicle 100 is rolling or heaving.

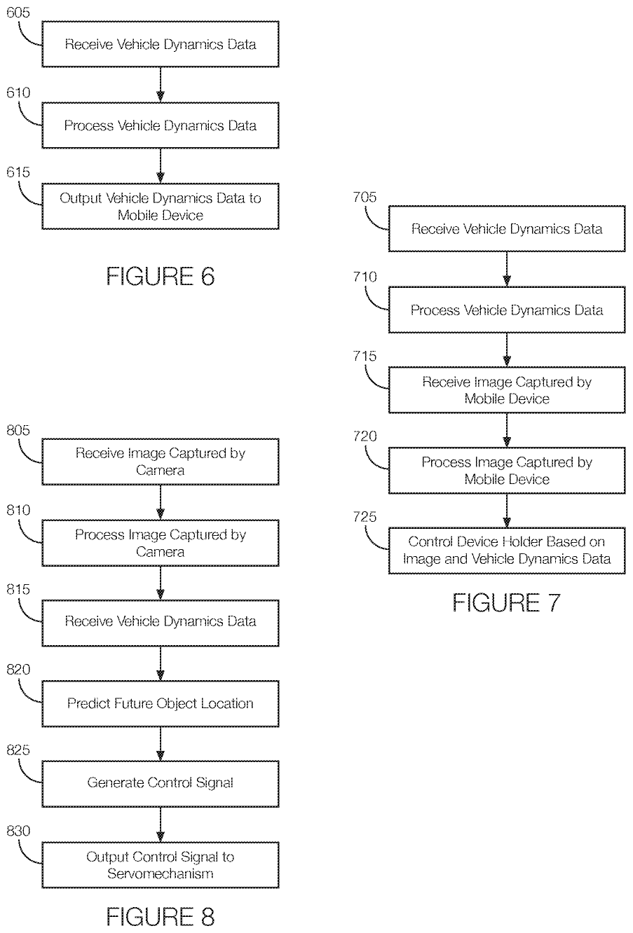

FIG. 6 is a flowchart of an example process 600 that may be executed by the vehicle processor 195 to output vehicle dynamics data to the mobile device 110 so the mobile device 110 can track an object external to the host vehicle 100 according to the vehicle dynamics data.

At block 605, the vehicle processor 195 receives vehicle dynamics data. The vehicle dynamics data may be collected by various vehicle sensors 185. The vehicle sensors 185 may collect vehicle characteristics such as changes in propulsion, brake pressure, a steering angle, a suspension height, a velocity, the output of a gyroscope, such as a MEMS gyroscope, or an accelerometer, headlight direction, etc. The aggregate of the data collected by the vehicle sensors 185 may be referred to as the vehicle dynamics data. The vehicle dynamics data may be output by the vehicle sensors 185 directly to the vehicle processor 195, to the vehicle memory 190, or both. Thus, the vehicle processor 195 may receive the vehicle dynamics data directly from the vehicle sensors 185 or by retrieving the vehicle dynamics data from the vehicle memory 190.

At block 610, the vehicle processor 195 processes the vehicle dynamics data. For instance, the vehicle processor 195 may extract information from the vehicle dynamics data that can be used to track the object external to the host vehicle 100. For instance, the vehicle processor 195 may determine whether the host vehicle 100 is accelerating, decelerating, or turning, whether the headlights of the host vehicle 100 are pointed in a direction other than straight ahead, whether the host vehicle 100 is pitched forward or backward, rolling, heaving, etc.

At block 615, the vehicle processor 195 outputs the vehicle dynamics data to the mobile device 110. The vehicle processor 195 may do so by commanding the vehicle communication interface 180 to provide the vehicle dynamics data to the accessory interface 135 of the device holder 105, which may in turn provide the vehicle dynamics data to the mobile processor 170 via the mobile communication interface 155. In some instances, the vehicle communication interface 180 may wirelessly transmit the images directly to the mobile communication interface 155 via, e.g., Bluetooth®, WiFi, or another wireless communication protocol.

The process 600 may return to block 605 after block 615.

FIG. 7 is a flowchart of another example process 700 that may be executed by the vehicle processor 195. In this process 700, the vehicle processor 195 controls the direction of the device holder 105 to track the object according to the vehicle dynamics data and images captured by the mobile device 110.

At block 705, the vehicle processor 195 receives vehicle dynamics data. The vehicle dynamics data may be collected by various vehicle sensors 185. The vehicle sensors 185 may collect vehicle characteristics such as changes in propulsion, brake pressure, a steering angle, a suspension height, a velocity, the output of a gyroscope, such as a MEMS gyroscope, or an accelerometer, headlight direction, etc. The aggregate of the data collected by the vehicle sensors 185 may be referred to as the vehicle dynamics data. The vehicle dynamics data may be output by the vehicle sensors 185 directly to the vehicle processor 195, to the vehicle memory 190, or both. Thus, the vehicle processor 195 may receive the vehicle dynamics data directly from the vehicle sensors 185 or by retrieving the vehicle dynamics data from the vehicle memory 190.

At block 710, the vehicle processor 195 processes the vehicle dynamics data. For instance, the vehicle processor 195 may extract information from the vehicle dynamics data that can be used to track the object external to the host vehicle 100. For instance, the vehicle processor 195 may determine whether the host vehicle 100 is accelerating, decelerating, or turning, whether the headlights of the host vehicle 100 are pointed in a direction other than straight ahead, whether the host vehicle 100 is pitched forward or backward, rolling, heaving, etc.

At block 715, the vehicle processor 195 receives images captured by the mobile device 110. The vehicle processor 195 may receive such images by way of the vehicle communication interface 180, the accessory interface 135, and the mobile communication interface 155. In some instances, the mobile communication interface 155 may wirelessly transmit the images directly to the vehicle communication interface 180 via, e.g., Bluetooth®, WiFi, or another wireless communication protocol.

At block 720, the vehicle processor 195 processes the images captured by the mobile device 110. Using an image processing technique, the vehicle processor 195 may process the images to detect an object external to the host vehicle 100.

At block 725, the vehicle processor 195 controls the device holder 105 according to the vehicle dynamics data and the images captured by the mobile device 110. For instance, the vehicle processor 195 predicts where the object will be relative to the host vehicle 100 at a future time based on the vehicle dynamics data, which may define how the host vehicle 100 is moving, based on how the object is moving, or both. The vehicle processor 195 may control the device holder 105 by outputting control signals to the servomechanism 130. The control signals may cause the device holder 105 to turn toward the object, accounting for the movement of the host vehicle 100 defined by the vehicle dynamics data. Thus, the control signal may compensate for the host vehicle 100 turning toward the object, turning away from the object, the object moving laterally relative to the host vehicle 100 while the host vehicle 100 is turning, stationary, or maintaining its direction, or the like. The control signal may also compensate for the host vehicle 100 accelerating or decelerating relative to the object, the object accelerating or decelerating relative to the host vehicle 100, etc. The vehicle processor 195 may command the servomechanism 130 of the device holder 105 to rotate to particular angular or linear positions based on the predicted or detected location of the object. The vehicle processor 195 may output control signals commanding the servomechanism 130 to particular angular or linear positions so the object will remain in the field of view of the camera 160.

The process 700 may return to block 705 so the vehicle processor 195 may continually monitor the location of the object via the images.

FIG. 8 is a flowchart of an example process 800 that may be executed by a mobile processor 170. For instance, the process 800 may allow the mobile processor 170 to control the rotation of the servomechanism 130, and therefore the direction of the device holder 105, based on images captured by the mobile device 110 and the vehicle dynamics data provided to the mobile device 110.

At block 805, the vehicle processor 195 receives an image. The image may be captured by the camera 160 and may include an object external to the vehicle. The camera 160 may store the image in the mobile memory 165 or transmit the image directly to the mobile processor 170. The mobile processor 170 may receive the image directly from the camera 160 or access the image from the mobile memory 165.

At block 810, the mobile processor 170 processes the image. Processing the image may include the mobile processor 170 performing an image processing technique to identify an object in the image.

At block 815, the mobile processor 170 receives vehicle dynamics data. The vehicle dynamics data may be collected by various vehicle sensors 185. The vehicle sensors 185 may collect vehicle characteristics such as changes in propulsion, brake pressure, a steering angle, a suspension height, a velocity, the output of a gyroscope, such as a MEMS gyroscope, or an accelerometer, headlight direction, etc. The aggregate of the data collected by the vehicle sensors 185 may be referred to as the vehicle dynamics data. The vehicle dynamics data may be output by the vehicle sensors 185 directly to the vehicle processor 195, to the vehicle memory 190, or both. The vehicle processor 195 may receive the vehicle dynamics data directly from the vehicle sensors 185 or by retrieving the vehicle dynamics data from the vehicle memory 190. The vehicle processor 195 may command the vehicle communication interface 180 to provide the vehicle dynamics data to the accessory interface 135 of the device holder 105, which may in turn provide the vehicle dynamics data to the mobile processor 170 via the mobile communication interface 155. In some instances, the vehicle communication interface 180 may wirelessly transmit the images directly to the mobile communication interface 155 via, e.g., Bluetooth®, WiFi, or another wireless communication protocol. Thus, the mobile processor 170 may receive the vehicle dynamics data via the mobile communication interface 155, which may receive the vehicle dynamics data from the accessory interface 135 or the vehicle communication interface 180.

At block 820, the mobile processor 170 predicts where the object will be relative to the host vehicle 100. The mobile processor 170 makes such a prediction by processing the image and by processing the vehicle dynamics data. In some instances, the mobile processor 170 is programmed to predict where the object will be relative to the host vehicle 100 at a future point in time. The mobile processor 170 may be programmed to determine an angular displacement of the object relative to the mobile device 110, the predicted location of where the object will be at a future point in time, or both.

At block 825, the mobile processor 170 generates a control signal to control the servomechanism 130 of the device holder 105. The mobile processor 170 generates the control signal based on the image and the vehicle dynamics data. For instance, the mobile processor 170 may generate the control signal that will cause the servomechanism 130 to turn the base 115 the amount of the angular displacement determined at block 820.

At block 830, the mobile processor 170 outputs the control signal to the servomechanism 130. The control signal may be provided to the servomechanism 130 via the accessory interface 135. That is, the mobile processor 170 may command the mobile communication interface 155 to transmit the control signal to accessory interface 135 and to the servomechanism 130. Receipt of the control signal by the servomechanism 130 may cause the servomechanism 130 to rotate the base 115 to the angular or linear position dictated by the control signal.

The process 800 may return to block 805 so the mobile processor 170 may continually monitor the location of the object via the images and vehicle dynamics data.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A mobile device holder comprising:
a base configured to rotate;
a mechanical linkage attached to the base and configured to receive a mobile device; and
a servomechanism operably connected to the base and configured to rotate the base in accordance with vehicle dynamics data and an image captured by the mobile device.

2. The mobile device holder of claim 1, wherein the vehicle dynamics data includes at least one of a change in propulsion, brake pressure, a steering angle, a suspension height, a velocity of a host vehicle, an output of a gyroscope or accelerometer, and a headlight direction.

3. The mobile device holder of claim 2, wherein the vehicle dynamics data includes the output of the gyroscope or accelerometer and wherein the output of the gyroscope or accelerometer indicates whether the host vehicle is at least one of pitching, rolling, and heaving.

4. The mobile device holder of claim 1, wherein the servomechanism is configured to receive a control signal output by the mobile device, the control signal representing an angular or linear position, and rotate to the angular or linear position represented by the control signal.

5. The mobile device holder of claim 1, wherein the servomechanism is configured to receive a control signal output by a vehicle processor, the control signal representing an angular or linear position, and rotate to the angular or linear position represented by the control signal.

6. The mobile device holder of claim 1, further comprising an actuator operatively connected to the mechanical linkage.

7. The mobile device holder of claim 6, wherein the actuator is configured to receive a control signal from one of the mobile device and a vehicle processor and tilt the mobile device up based at least in part on vehicle dynamics data indicating that a host vehicle is pitching forward.

8. The mobile device holder of claim 6, wherein the actuator is configured to receive a control signal from one of the mobile device and a vehicle processor and tilt the mobile device down based at least in part on vehicle dynamics data indicating that a host vehicle is pitching backward.

9. The mobile device holder of claim 6, wherein movement of the actuator causes the mechanical linkage to telescope.

10. The mobile device holder of claim 1, further comprising an accessory interface configured to communicatively connect the mobile device to a vehicle communication interface.

11. A vehicle system comprising:
a mobile device holder having a base configured to rotate, a mechanical linkage attached to the base and configured to receive a mobile device, and a servomechanism operably connected to the base and configured to rotate the base in accordance with vehicle dynamics data and an image captured by the mobile device;
a vehicle processor, in a host vehicle, programmed to output the vehicle dynamics data to the mobile device.

12. The vehicle system of claim 11, wherein the vehicle dynamics data includes at least one of a change in propulsion, brake pressure, a steering angle, a suspension height, a velocity of the host vehicle, an output of a gyroscope or accelerometer, and a headlight direction.

13. The vehicle system of claim 12, wherein the vehicle dynamics data includes the output of the gyroscope or accelerometer and wherein the output of the gyroscope or accelerometer indicates whether the host vehicle is at least one of pitching, rolling, and heaving.

14. The vehicle system of claim 11, wherein the servomechanism is configured to receive a control signal output by the mobile device, the control signal representing an angular or linear position, and rotate to the angular or linear position represented by the control signal.

15. The vehicle system of claim 11, wherein the servomechanism is configured to receive a control signal output by the vehicle processor, the control signal representing an angular or linear position, and rotate to the angular or linear position represented by the control signal.

16. The vehicle system of claim 11, further comprising:
a vehicle communication interface,
wherein the device holder includes an accessory interface configured to communicatively connect the mobile device to the vehicle communication interface.

17. The vehicle system of claim 16, wherein the vehicle processor is programmed to command the communication interface to transmit the vehicle dynamics data to the mobile device via the accessory interface.

18. The vehicle system of claim 11, wherein the device holder includes an actuator operatively connected to the mechanical linkage, and wherein the actuator is configured to receive a control signal from one of the mobile device and the vehicle processor and tilt the mobile device up based at least in part on vehicle dynamics data indicating that a host vehicle is pitching forward.

19. The vehicle system of claim 11, wherein the device holder includes an actuator operatively connected to the mechanical linkage, and wherein the actuator is configured to receive a control signal from one of the mobile device and the vehicle processor and tilt the mobile device down based at least in part on vehicle dynamics data indicating that a host vehicle is pitching backward.

20. A vehicle system comprising:
a mobile device holder having a base configured to rotate, a mechanical linkage attached to the base and configured to receive a mobile device, and a servomechanism operably connected to the base and configured to rotate the base in accordance with vehicle dynamics data and an image captured by the mobile device;
a vehicle processor, in a host vehicle, programmed to receive the image captured by the mobile device, generate a control signal based on the image and the vehicle dynamics data, and output the control signal to the servomechanism,
wherein the servomechanism rotates the base to point a camera of the mobile device toward an object external to the host vehicle that appears in the image to track the image while the host vehicle is moving.
